(19) United States
(12) Patent Application Publication
(10) Pub. No.: US 2020/0277136 A1
(43) Pub. Date: Sep. 3, 2020

(54) WASTEBASKET WITH ENHANCED LOAD-BEARING CAPACITY

(71) Applicant: Joung Hak CHANG, Anyang-si (KR)

(72) Inventor: Joung Hak CHANG, Anyang-si (KR)

(21) Appl. No.: 16/643,754

(22) PCT Filed: Sep. 13, 2018
(86) PCT No.: PCT/KR2018/010724

§ 371 Date: Mar. 2, 2020

(30) Foreign Application Priority Data
Sep. 27, 2017 (KR) 10-2017-0124987
Sep. 27, 2017 (KR) 10-2017-0124988

(51) Int. Cl. B65F 1/06; B65F 1/16

(52) U.S. Cl. CPC B65F 1/062; B65F 1/16

(57) ABSTRACT

The present invention relates to successive plastic bags, a plastic bag cartridge, and a wastebasket containing the plastic bag cartridge. The successive plastic bags include unit plastic bags in each of which symmetrical, sideways M-shaped folded portions (M1 and M2) are provided on both sides thereof in a longitudinal direction and a sealing line is provided in an end portion thereof opposite to the entrance end thereof in a state in which one of both the sides has been turned to the other side around 180 degrees along the center portion thereof in the longitudinal direction. The unit plastic bags have same specifications, are successively connected to each other and are wound in a roll pack form, a cutting line is provided, and the entrance end of the subsequent unit plastic bag is opened when the each unit plastic bag is separated.

### TECHNICAL FIELD

The present invention relates to a wastebasket, and more specifically to a wastebasket in which a plastic bag is contained.

### BACKGROUND ART

Waste is always generated. Accordingly, wherever people live, there are wastebaskets. People cover wastebaskets with plastic bags, and throw waste into the plastic bags. Thereafter, they separate the plastic bags from the wastebaskets, and discard the plastic bags together with the waste. Without such plastic bags, wastebaskets become dirty due to waste, which is bad in terms of sanitation. Furthermore, people feel inconvenient when they throw waste into wastebaskets. Due to these points, people want plastic bags sufficient to use, and vinyl pack products meeting this need are supplied to the market.

Meanwhile, there are frequent cases where a plastic bag for a wastebasket is not available. In these cases, embarrassment is probably experienced by many people. Accordingly, there occurs the idea in which if a plastic bag is contained in a wastebasket, this would be much more comfortable. For example, Korean Utility Model Registration No. 443070 (Patent document 1) and Korean Utility Model Registration No. 468598 are based on such ideas.

The prior arts propose the solutions in which if the plastic bag roll packs of FIG. 5 (not a drawing of the present specification) of Patent document 1 and FIG. 3 (not a drawing of the present specification) of Patent document 2 are contained and used in wastebaskets, users do not need to make an effort to find plastic bags.

However, as the size of a wastebasket is increased, a problem that has not been foreseen in the prior arts has been found. As the volume of a wastebasket is increased, the volume of a plastic bag used in the wastebasket increases naturally. Then, the load of waste that the plastic bag has to bear will also increase. Load-bearing capacity becomes a problem. The plastic bags of the prior arts are easily torn as a load increases. In particular, when the amount of waste increases because heavy waste such as a bottle or a can is introduced into such a plastic bag, the bottom thereof is broken. The bottom sealing line thereof is very fragile.

It is difficult to require a user to take special measures to solve this problem. For example, it may be contemplated that a user is asked to use two plastic bags at the same time or not to put heavy waste into the wastebasket. However, the user's interest is to use a waste bag as easily as possible, not to use it carefully. Increasing the strength of the material of the waste bag may be one way. However, in this case, the price goes up. The waste bag is also waste. There is no user who is willing to pay more for waste.

Meanwhile, a user does not want to touch a bag containing waste with his or her hand if possible. Accordingly, a user does not want to perform the operation of opening the entrance of a waste bag every time he or she puts waste in the bag. If so, it is necessary to keep the waste bag open. However, when waste is contained in the waste bag, the entrance of the waste bag is pulled downward due to the load of the waste. Then, a problem arises in that the user needs to open the entrance while holding the entrance with his or her hands when introducing waste into the waste bag. That is, there is a need for the entrance to be effectively kept open on the top of a wastebasket despite the load of waste.

In order to solve these problems, the inventor of the present invention has realized that a radically different approach needs to be made beyond the conventional concepts of a plastic bag and a wastebasket after repeated trial and error, and has come to complete the present invention.

### DISCLOSURE

### Technical Problem

An object of the present invention is to propose a new concept-based plastic bag cartridge that that is contained and used in a wastebasket. Furthermore, another object of the present invention is to propose an unprecedented, novel wastebasket in which a plastic bag cartridge is contained.

More specifically, an object of the present invention is to propose the following plastic bag:

First, the present invention is intended to implement a plastic bag that has enhanced load-bearing capacity, even though the volume thereof is increased. The fabrication of a plastic bag that is 500 to 1,000 mm in length and 200 to 500 mm in diameter when folded is taken into account.

Second, manufacturing cost has to be inexpensive. Since there is concern that the selection and changing of the composition of the material of a plastic bag may lead to an increase in manufacturing cost, the present invention proposes a method of enhancing load-bearing capacity only by structural improvement.

Third, an object of the present invention is to propose the new structure of a wastebasket that may be stably kept open despite the load of waste when a plastic bag is taken from a cartridge and is installed in the wastebasket.

This further promotes the popularization of the wastebasket in which a plastic bag is contained.

Meanwhile, other objects of the present invention not specified will be further considered within the range that can be easily inferred from the following detailed description and effects.

### Technical Solution

According to a first aspect of the present invention, there is provided a wastebasket in which one plastic bag cartridge is contained, wherein:

a plastic bag cartridge including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to the other side around 180 degrees along a center portion thereof in the longitudinal direction, the plastic bag cartridge being packaged such that the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line, is replaceably mounted in a bottom portion of the wastebasket; and

an adhesive film configured to enhance force holding the entrance of the unit plastic bag is disposed along an upright surface (135) surrounding the top entrance of the wastebasket, and a lid (120) configured to close the top entrance of the wastebasket while coming into contact with a protruding surface (130) formed perpendicular to the upright surface (135) is provided.

According to a second aspect of the present invention, there is provided a wastebasket in which one plastic bag cartridge is contained inside the wastebasket and a vinyl sheet cartridge is attached to any surface of an outside of the wastebasket body, wherein:

the plastic bag cartridge is configured such that successive plastic bags in which unit plastic bags are successively connected to each other are contained therein, is replaceably mounted in a bottom portion of the wastebasket, and is packaged such that a sealing line is provided in an end portion of each of the unit plastic bags opposite to an entrance end thereof, the unit plastic bags have same specifications and are successively connected to each other, a cutting line is provided between a sealing line of the each unit plastic bag and a subsequent unit plastic bag, and an entrance end of the subsequent unit plastic bag is opened when the each unit plastic bag is separated by cutting the cutting line; and

the vinyl sheet cartridge is configured such that lid protecting vinyl sheets are folded and stacked therein, and an adhesive film configured to allow each of the lid protecting vinyl sheets to be adhered thereto is disposed on an inner surface of a wastebasket lid so that the lid protecting vinyl sheet is taken from the vinyl sheet cartridge and adhered to the inner surface of the wastebasket lid.

Preferably, an adhesive film configured to enhance force holding the entrance of the unit plastic bag may be disposed along an upright surface surrounding the top entrance of the wastebasket, and the wastebasket lid may close the top entrance of the wastebasket while coming into contact with a protruding surface formed perpendicular to the upright surface.

According to a third aspect of the present invention, there is provided successive plastic bags including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to the other side around 180 degrees along a center portion thereof in the longitudinal direction, wherein the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line.

According to a fourth aspect of the present invention, there is provided successive plastic bags including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to the other side around 180 degrees along a center portion thereof in the longitudinal direction, wherein the unit plastic bags have same specifications, are successively connected to each other and are folded and stacked with a location of the sealing line changed at intervals of 180 degrees, a cutting line is provided between a sealing line of each unit plastic bag and a subsequent unit plastic bag, and an entrance end of the subsequent unit plastic bag is opened when the each unit plastic bag is separated by cutting the cutting line.

According to a fifth aspect of the present invention, there is provided a plastic bag cartridge including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to the other side around 180 degrees along a center portion thereof in the longitudinal direction, wherein the unit plastic bags have same specifications, are successively connected to each other, and are wound in a roll pack form or folded and stacked with a location of the sealing changed at intervals of 180 degrees,

wherein the plastic bag cartridge is packaged such that a cutting line is provided between a sealing line of each unit plastic bag and a subsequent unit plastic bag and an entrance end of the subsequent unit plastic bag is opened when the each unit plastic bag is separated by cutting the cutting line, is replaceably mounted in a wastebasket, and is configured such that the subsequent plastic bag is opened and disposed in the wastebasket when the each unit plastic bag is separated from the wastebasket.

According to a sixth aspect of the present invention, there is provided a wastebasket in which one or more plastic bag cartridges are contained, wherein:

a plastic bag cartridge including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to the other side around 180 degrees along a center portion thereof in the longitudinal direction, the plastic bag cartridge being packaged such that the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line, is replaceably mounted in a bottom portion of the wastebasket; and

protruding portion lines each including a plurality of protruding portions configured to hold an entrance of each of the unit plastic bags supplied from the plastic bag cartridge are disposed along both opposite sides of a top entrance of the wastebasket.

### Advantageous Effects

The objects of the present invention are easily achieved by the above-described technical solutions. Although the volume of the plastic bag has been increased, its load-bearing capacity has been rather enhanced. Furthermore, when the plastic bag is installed in the wastebasket, it may be stably installed with the entrance of the bag open.

Meanwhile, even when the effects are not explicitly described herein, it is added that the effects described in the following specification and potential effects thereof expected by the technical features of the present invention are treated as described in the specification of the present invention.

### DESCRIPTION OF DRAWINGS

FIGS. 1 and 2 show the schematic external configuration of a wastebasket (100) according to any preferred embodiment of the present invention, FIG. 1 showing the wastebasket (100) in a closed state and FIG. 2 showing the wastebasket (100) in an open state;

FIG. 3 is an enlarged view showing the configuration of the entrance (E) of the wastebasket (100) shown in FIG. 2 and its surroundings;

FIGS. 4 and 5A-5B show the configuration of a bottom inside a wastebasket (100) according to any preferred embodiment of the present invention;

FIG. 6 is a view showing connected plastic bags (30) in a roll pack form according to any preferred embodiment of the present invention;

FIG. 7 is a diagram showing an example of the planar configuration of a unit plastic bag (10) in a folded state according to any preferred embodiment of the present invention;

FIGS. 8 and 9 are views showing the entrance and folded configurations of a unit plastic bag (10) constituting part of successive plastic bags (30) according to any preferred embodiment of the present invention;

FIG. 10 is a view showing feature points of the entrance line (11) of the unit plastic bag (10) in a folded state according to the present invention;

FIG. 11 is a view schematically illustrating the configuration of support partitions (14, 15, 16 and 17) separated by the sealing line (18) of FIG. 7 and generated in the center portion of the bottom of the inside of the unit plastic bag (10);

FIGS. 12 and 13 are views showing a state in which a unit wastebasket bag (10) of a plastic bag cartridge according to the present invention is used in a wastebasket (100) according to any preferred embodiment of the present invention;

FIG. 14 is a view showing a state in which a lid protecting vinyl sheet (210) is attached to a lid inner surface (129) in a wastebasket (100) according to another preferred embodiment of the present invention;

FIG. 15 is an enlarged view showing the lid inner surface (129) of FIG. 14;

FIG. 16 shows an example of the configuration of the vinyl sheet cartridge (200) of FIG. 14; and

FIG. 17 shows an example of a wastebasket (100) according to another preferred embodiment of the present invention.

※ It is noted that the accompanying drawings are presented as examples to help to understand the technical spirit of the present invention and the scope of the present invention is not limited by the accompanying drawings.

### MODE FOR INVENTION

In the following description of the present invention, when it is determined that detailed descriptions of related well-known functions are apparent to those skilled in the art and may make the gist of the present invention unnecessarily obscure, they will be omitted.

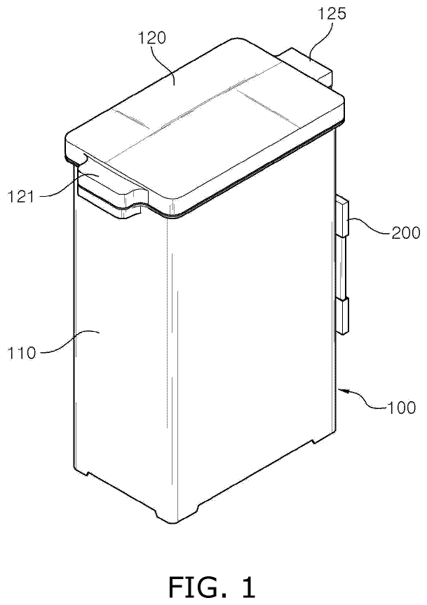

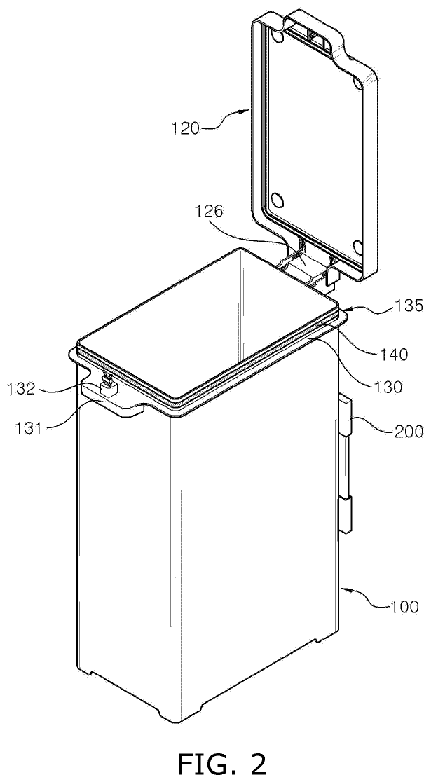

FIGS. 1 and 2 show the schematic external configuration of a wastebasket 100 according to any preferred embodiment of the present invention. FIG. 1 shows the wastebasket 100 in a closed state, and FIG. 2 shows the wastebasket 100 in an open state.

The wastebasket 100 made of a plastic or metal material includes a body 110 and a lid 120. The lid 120 includes hinge members 125 and 126 and a grip 121, and selectively opens and closes the entrance of the body 110.

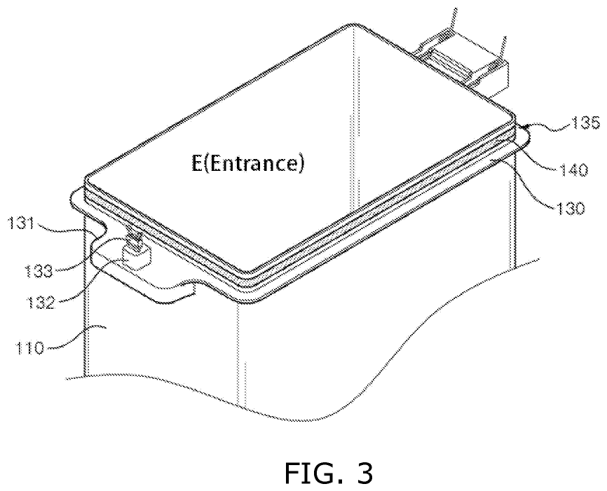

When the wastebasket lid 120 is opened, a wastebasket top entrance E is opened, as shown in FIGS. 2 and 3. An upright surface 135 surrounding the top entrance E is formed by a protruding surface 130 that is perpendicular to the upright surface 135, extends in a circumferential direction, and is formed like a flange. An adhesive film 140 is disposed along a surface of the upright surface 135. AS will be described later, this adhesive film 140 is used as a means for enhancing force that holds the entrance of a plastic bag contained in the wastebasket 100.

A protruding grip portion 131 is formed in the same plane as the protruding surface 130, and a lid locking portion 132 is disposed on the protruding grip portion 131. The catch of the lid 120 is fitted into the lid locking portion 132 in a fitting manner. There is disposed a well-known latch 133 that is operated by a method in which fitting is released by pressing the grip once more.

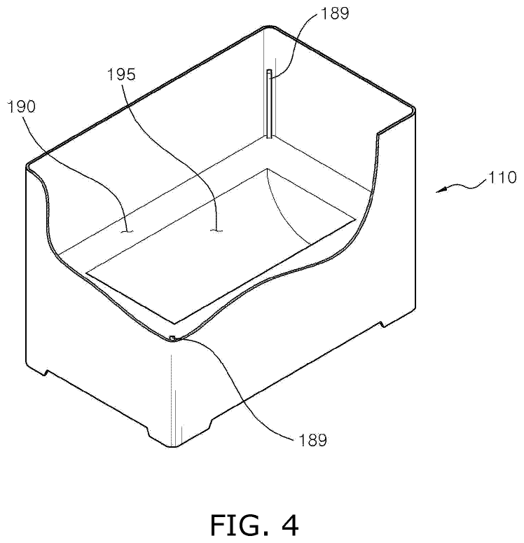

FIG. 4 visually shows an example of the lower configuration of the wastebasket 100 according to the present invention. A bottom housing 190 is disposed in a bottom surface in the wastebasket, and a cartridge accommodation portion 195 having a shape depressed to a predetermined length from the bottom surface is formed in the bottom housing 190. A plastic bag cartridge to be described later is accommodated through the cartridge accommodation portion 195.

The wastebasket may be formed in a hexahedral shape or a cylindrical shape. There are no limitations to the specifications, shape and size thereof. As shown in the drawings, in the case of a hexahedral wastebasket, it is preferable that supports 189 be disposed in the lower portions of the corners of the inside of the wastebasket 100.

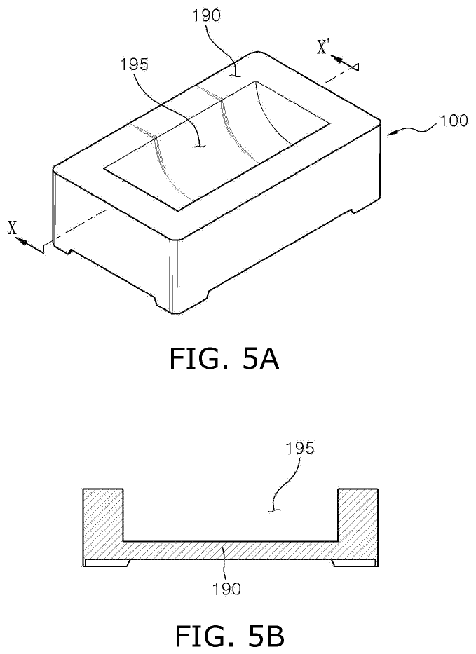

FIGS. 5A and 5B show only the bottom configuration of the wastebasket 100 separately. As shown in FIG. 5A, the cartridge accommodation portion 195 is a space the cross section of which is an approximately depressed semicircular shape. As shown in FIG. 5B taken along line X-X of FIG. 5A, the cartridge accommodation portion 195 is an empty space before the plastic bag cartridge is mounted therein. It is preferable that the hatched portion of the bottom housing 190 be also an empty space. In other words, the configuration of the bottom housing 190 is defined by boundary surfaces.

The cartridge accommodation portion 195 is mounted with a plastic bag cartridge according to the present invention. The plastic bag cartridge will now be described. The plastic bag cartridge of the present invention may be packaged and sold as an independent product by itself. Furthermore, it may be preferably mounted and used on the wastebasket.

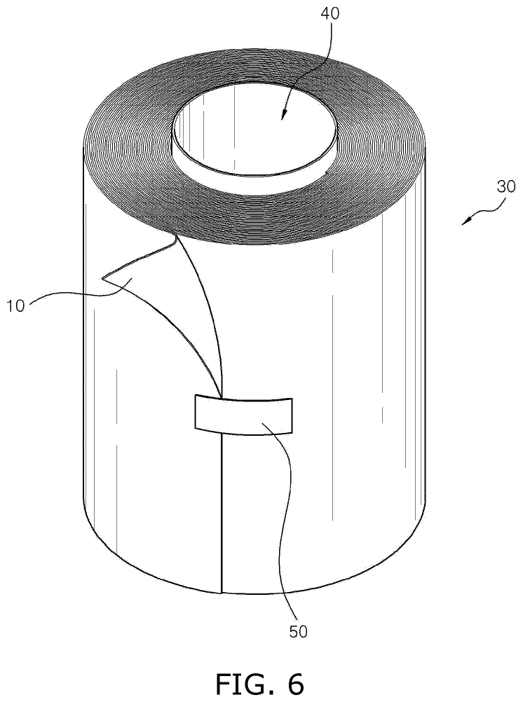

FIG. 6 schematically illustrates the roll pack configuration of a plastic bag cartridge according to any preferred embodiment of the present invention.

The plastic bag cartridge has a form in which successive and connected unit plastic bags 10 to be described later are wound around a paper cylinder 40 with an open top and bottom. Furthermore, a first unit plastic bag 10 is fastened to a roll pack 30 with a sticker 50.

As described above, the plastic bag roll pack 30 according to the preferred embodiment of the present invention may have the same form as a toilet paper roll. In another preferred embodiment of the present invention, the plastic bag cartridge has a structure in which unit plastic bags 10 are successively folded and stacked and pulled out one by one for the purpose of use like Kleenex™ tissues. The plastic bag cartridges of these two embodiments each include the successive plastic bags of the unit plastic bags 10. In these plastic bag cartridges, the configurations of the unit plastic bags 10 are substantially the same. Accordingly, the configuration of one unit plastic bag 10 will be described.

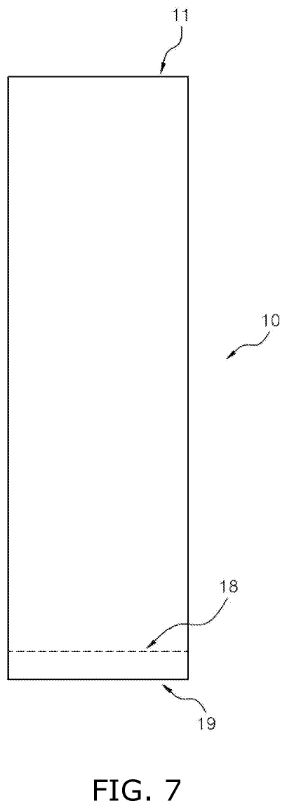

FIG. 7 schematically shows the planar configuration of a unit plastic bag 10 according to any preferred embodiment of the present invention.

The unit plastic bag 10 is substantially the same as the conventional plastic bag in that it has an approximately rectangular structure, both ends thereof, i.e., the entrance and cut end thereof, in the longitudinal direction have the same configuration, and there is a sealing line sealed parallel to these ends. However, the unique configuration of the present invention in which, as will be described below, folded portions are formed on both sides in the longitudinal direction and sealing lines and cutting lines are sequentially formed on a continuous plastic member in a double/triple folded and stacked state is a technology that was not thought of in the conventional technology.

As a waste bag for separate collection purposes, the length of the unit plastic bag is preferably 500 to 1000 mm. The inventor of the present invention took a length of 700 mm, and fabricated the unit plastic bag. The width of the entrance of the unit plastic bag was 450 mm when the unit plastic bag was unfolded. However, FIG. 7 shows a state in which the unit plastic bag is folded a few times in the widthwise direction, and the width in this state was about 110 to 120 mm. The width may be smaller or larger.

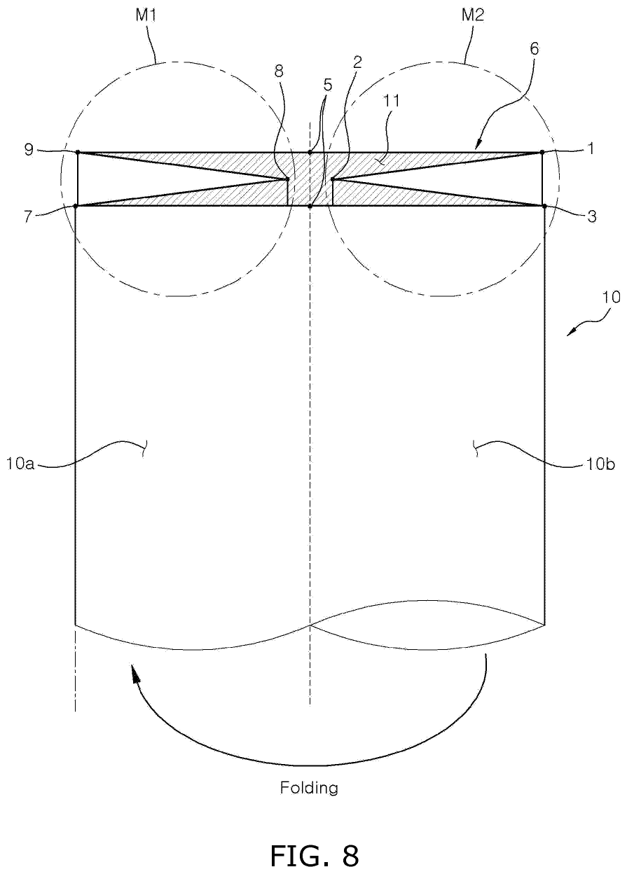

The entrance line 11 of the unit plastic bag 10 is open, and the opposite side is sealed by the sealing line 18. Meanwhile, the unit plastic bag 10 is folded a few times in the widthwise direction, and thus the entrance line 11 has an approximately zigzag form (exactly, it will be described again with reference to FIGS. 8 to 10). In contrast, although the sealing line 18 will be descried with reference to FIG. 11, a plurality of support partitions is disposed by the sealing line 18.

The end line 19 of the unit plastic bag 10 constitutes one side of a cutting line not shown. The other side of the cutting line constitutes the entrance line 11 of another connected unit plastic bag 10. In other words, the end line 19 of the first unit plastic bag is the entrance line 11 of a second unit plastic bag connected to the first unit plastic bag. These unit plastic bags are connected through the cutting line until they are separated by cutting. The configurations of all the unit plastic bags 10 of the plastic bag cartridge configured in a connected plastic bag form are the same. Furthermore, if we understand the configuration of the entrance line 11, the overall configuration of the plastic bag cartridge may be intuitively or analytically understood.

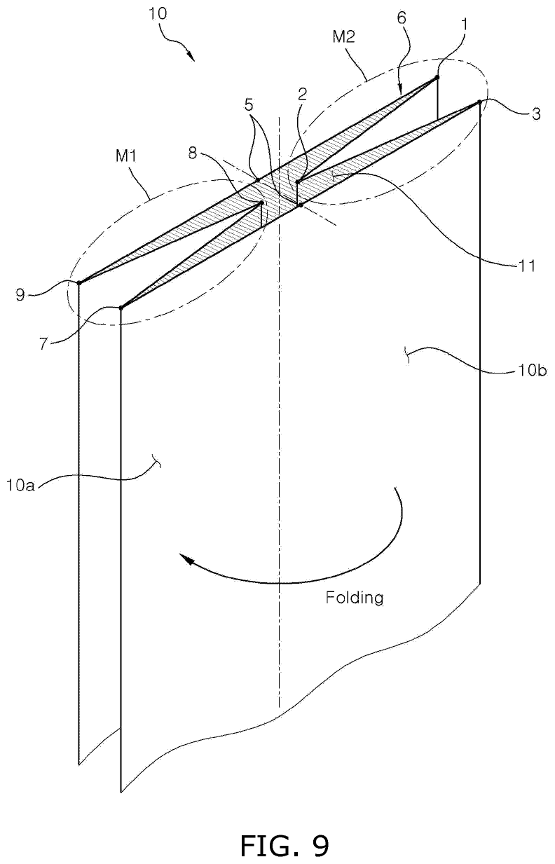

See FIGS. 8 and 9. FIG. 8 shows the enlarged configuration of the entrance line 11 of the unit plastic bag 10 and its surroundings. Folded portions M1 and M2 are formed on both sides of the unit plastic bag 10 in the longitudinal direction. The pair of folded portions M1 and M2 form an approximate M shape in a plan view when viewed from above after the entrance has been slightly opened. The shapes of the pair of folded portions M1 and M2 are symmetrical to each other. Accordingly, when the folded portion M2 on the right has an M shape, the folded portion M1 on the left forms an inverted M shape. In this case, the M shape does not mean an exact coincidence with the letter M, but is borrowed to express a configuration in which a plastic bag sheet is folded on both sides along the longitudinal direction. In fact, as will be described later, the portions of a member are in close contact with each other because the plastic bag does not have shape retention force and is packed in a folded and stacked state. It is added that the M shape is observed only when the entrance is slightly opened with hands.

Since the specifications of the connected plastic bags are all the same, the configuration shown in FIG. 8 applies equally to all the plastic bags connected in the longitudinal direction.

In the drawing, eight feature points are marked on the entrance line for convenience of description. In the entrance line 11 of the folded part M1 on the left side, the line extends in the sequence of 5, 9, 8, 7 and 5. In the entrance line 11 of the folded part M2 on the right side, the line extends in the sequence of 5, 1, 2, 3 and 5. The size of the distance between the feature points 2 and 8 affects the M shape and also the volume of the waste bag. When a larger volume is desired, the distance between the feature points 2 and 8 is preferably 0 to 10 mm. Even when the distance is zero, there is no problem with being folded due to material properties without shape retention force.

Meanwhile, 5 is given to two of the above feature points. The reason for this is as follows:

From the state of FIG. 8, the member is folded around 180° along a center portion (indicated by the dotted line) in the longitudinal direction so that the right portion 10b of the member is superimposed on the left portion 10a of the member. This allows for the two feature points 5 to become a single feature point 5.

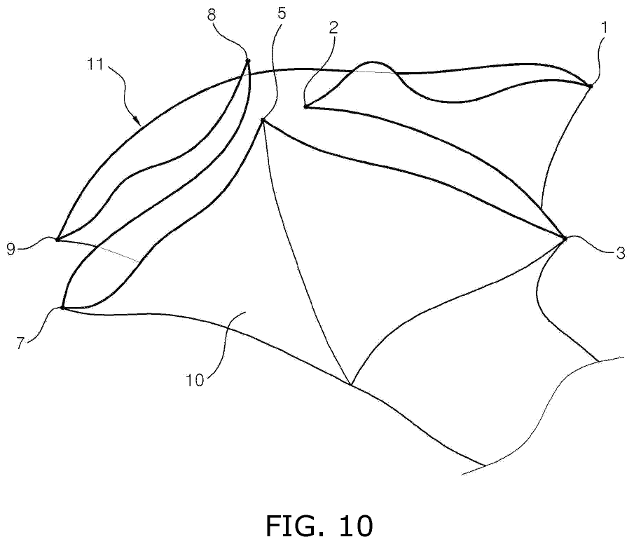

FIG. 10 more naturally shows the entrance line 11 in an enlarged view. The fully folded entrance line 11 of the unit plastic bag 10 is opened by slightly holding and pulling the feature point 3. The entrance line part extending in the sequence of feature points 5 (not shown), 9, 8, 7 and 5 corresponds to the left portion 10a of the member of FIG. 8. Furthermore, the entrance line part extending in the sequence of feature points 5, 3, 2, 1 and 5 (not shown) corresponds to the right portion 10b of the member shown in FIG. 8.

It is assumed that the unit plastic bag 10 of the present invention is separated from the roll pack 30, which is a plastic bag cartridge, and is then used. This allows the unit plastic bag 10 to be separated from the roll pack 30 along the cutting line (19 in FIG. 7). One side of the unit plastic bag 10 is closed by the sealing line 18, and the other side is opened by the entrance line 11. By doing so, a waste bag is formed. The entrance line 11 has already been described. The internal configuration of the sealing line 18 is important. The reason for this is that the load of waste introduced into the plastic bag does not cause a problem with the entrance side but causes a problem with the lower configuration of the plastic bag where the sealing line 18 is present.

A description will now be given again. The M-shaped folded portions M1 and M2 are formed on both sides of the member of the unit plastic bag 10. When viewed from the point of view of FIGS. 8 to 10, inward folding is performed such that the line of feature points 8 in the longitudinal direction and the line of feature points 2 in the longitudinal direction are formed. This results in two folded portions. From this state, folding is performed around 180° along the center portion, as shown in FIG. 9. This results in 2×2, 4 folded portions. This folded state is applied to the overall plastic bag member. Thereafter, sealing lines and cutting lines are allocated at predetermined intervals. The entrance structure formed by the cutting line has been fully described in FIGS. 8 to 10. The internal structure formed by the sealing line will now be described below.

FIG. 11 provides the description. Since the sealing line is formed across the member in the state where there are four folded portions, four support partitions 14, 15, 16 and 17 are formed on the bottom of the unit plastic bag 10. Furthermore, four valleys o, p, q and r are formed between the four support partitions 14, 15, 16 and 17. The height of these support partitions refers to the length of the sealing line. Furthermore, this corresponds to the width of the unit plastic bag 10 in a state in which the unit plastic bag 10 is wound around the roll pack, i.e., a folded state. This may be about 110 to 120 mm.

There is formed a structure in which the support partitions 14, 15, 16 and 17 rise like mountains in the center portion of the bottom of the plastic bag 10. The sealing line rises in the vertical direction in four directions, which improves the resistance to the load of waste to be introduced.

As a result, in the present invention, the sealing line forms four load-bearing members. Furthermore, the support partitions 14, 15, 16 and 17 formed in the center portion of the bottom of the plastic bag provide shape retention force to the center portion of the bottom of the plastic bag. This is helpful in throwing away a small amount of light waste.

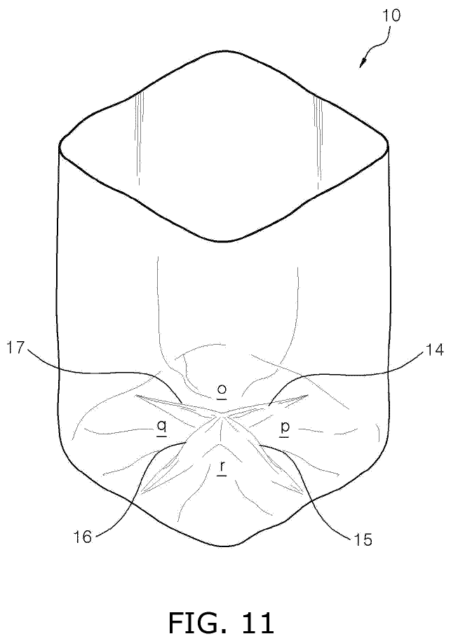

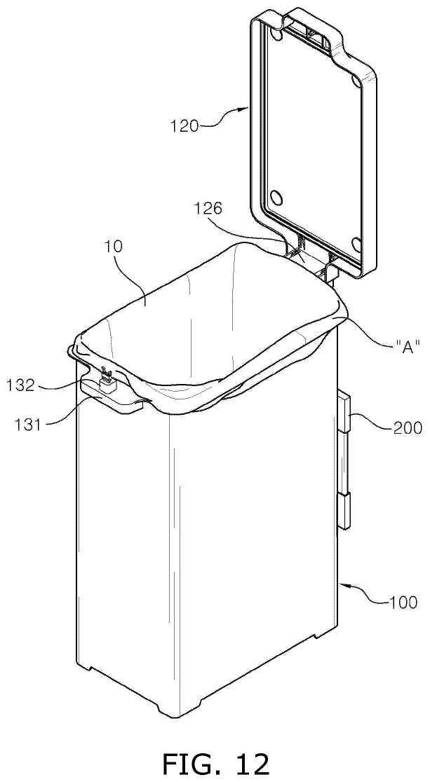

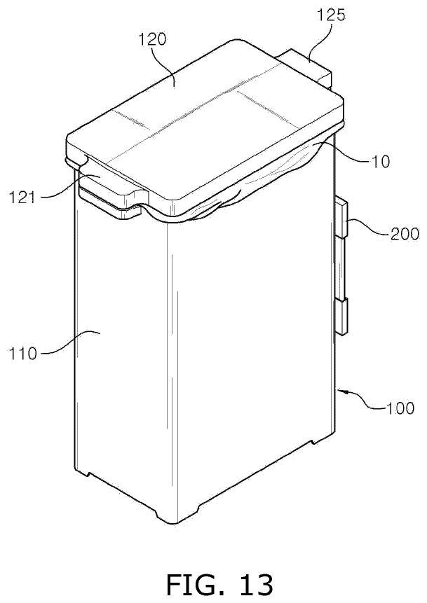

FIGS. 12 and 13 illustrate a state in which the unit plastic bag 10 is used with reference to the embodiment of the present invention shown in FIGS. 1 and 2.

In FIG. 12, a cartridge accommodation portion is disposed in the lower portion of the inside of the body of a wastebasket 100. The above-described successive plastic bags are installed in the cartridge accommodation portion as a plastic bag cartridge, e.g., in a roll pack form. After the roll pack has been installed in the cartridge accommodation portion, a first unit plastic bag 10 is taken from the roll pack, an end portion of the entrance of the unit plastic bag 10 is bent along the upright surface 135 of the top entrance of the wastebasket 100 in “a state of being connected to a subsequent unit plastic bag,” and then the end portion of the entrance of the unit plastic bag 10 is brought into close contact with the upright surface 135 of the top entrance of the wastebasket 100, as shown in portion “A.” By doing so, the adhesive film 140 formed on the upright surface 135 and the surface of the end of the entrance of the unit plastic bag 10 come into close contact with each other along the circumference of the top entrance of the wastebasket, and are then attached to each other naturally. Since overall attachment is performed throughout 360°, the unit plastic bag 10 is securely fastened to the upper portion of the wastebasket in a state in which the entrance of the unit plastic bag 10 is opened. In the state, the wastebasket lid 120 is closed, as shown in FIG. 13.

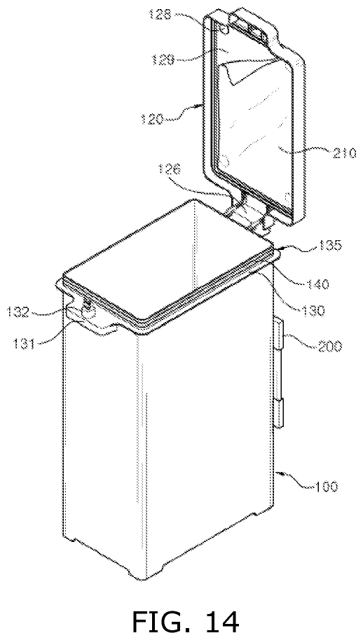

FIGS. 14 to 16 show a wastebasket according to another preferred embodiment of the present invention. In the present embodiment, a vinyl sheet cartridge 200 containing folded and stacked lid protecting vinyl sheets 210 configured to prevent the inner surface of a lid 120 from being contaminated with waste is attached particularly to any surface of the outside of a body 110.

As shown in FIG. 14, a plurality of vinyl sheet adhesion films 128 is separately disposed at the corners of the inner surface 129 of the wastebasket lid 120. Furthermore, an approximately rectangular lid protecting vinyl sheet 210 is adhered to the inner surface 129 of the wastebasket lid via the vinyl sheet adhesion films 128. This lid protecting vinyl sheet 210 prevents introduced waste from coming into direct contact with the inner surface 129 of the wastebasket lid when the waste is introduced into the wastebasket 100, thereby enhancing the sanitation of the wastebasket lid.

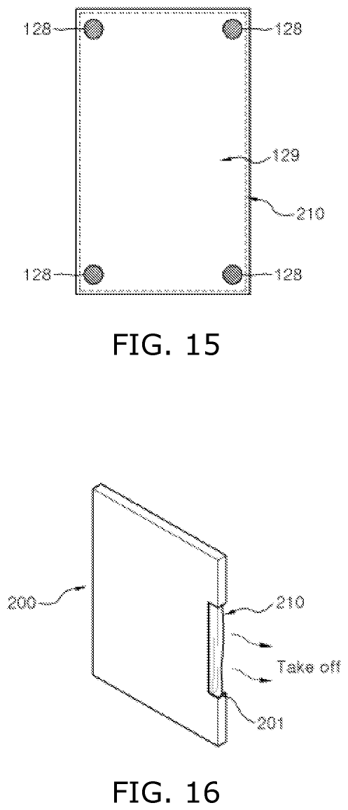

As shown in FIG. 15, the lid protecting vinyl sheet 210 comes into close contact with and is then adhered to the vinyl sheet adhesion films 128 disposed on the four corner portions of the lid inner surface 129. The locations at which the vinyl sheet adhesion film 128 are disposed and the number thereof are selected as desired. The adhesive films 128 are adhesion means well known as means for selectively attaching and detaching a member. However, it is added that the configuration “lid protecting vinyl sheet 210” is novel and the effect in which the adhesion means are disposed on the inner surface 129 of the wastebasket lid 120 and the sanitation of the lid is provided using a unprecedented method is novel.

Meanwhile, in the present invention, there may be prevented the burden in which a user has to find a new component means called the lid protecting vinyl sheet 210 somewhere in a hard way. In other words, the vinyl sheet cartridge 200 is attached to any one surface of the outside of the wastebasket body 110.

FIG. 16 shows an example of the configuration of the vinyl sheet cartridge 200 according to the present invention. As shown in the drawing, a number of lid protecting vinyl sheets 210 are folded and contained in the vinyl sheet cartridge 200, and an entrance 201 formed as a cutout is formed in the surface of one side of the vinyl sheet cartridge 200. A user may take one lid protecting vinyl sheet 210 out through the entrance 201, and may then adhere and use the lid protecting vinyl sheet 210 onto the wastebasket lid inner surface 129, as shown in FIGS. 14 and 15. An existing adhered lid protecting vinyl sheet 210 is separated from the lid inner surface 129 and discarded into the wastebasket 100, and a new vinyl sheet 210 is taken out via the vinyl sheet cartridge 200 and newly adhered onto the lid inner surface 129.

The vinyl sheet cartridge 200 of FIG. 16 is attached to any one surface of the wastebasket body 110 by a means such as an adhesive or sticking agent. The vinyl sheet is composed of an approximately rectangular sheet as described above. It is sufficient if the size of the vinyl sheet protects the lid inner surface 129. Accordingly, the size of the vinyl sheet will be previously determined by considering the size of the wastebasket, and then the vinyl sheet will be fabricated. The size and material of the vinyl sheet cartridge 200 in which such vinyl sheets are sequentially folded and contained are selected as desired. The vinyl sheet cartridge 200 preferably have specifications in which the shape thereof is an approximately rectangular shape and the length of each side thereof ranges from 150 to 200 mm.

FIG. 17 shows the configuration of a wastebasket 100 according to still another embodiment of the present invention. As shown in the drawing, four plastic bag cartridges are contained, and unit plastic bags 331, 332, 333 and 334, which may individually accommodate waste according to the principle of FIG. 12, are installed.

However, in the present embodiment, protruding portions 230 are disposed alongside each other on both sides in the longitudinal direction in order to enhance the support force used when a plastic bag accommodates waste, and thus the entrance lines of the unit plastic bags 331, 332, 333 and 334 are hung on the protruding portion 230. More preferably, an adhesive film such as the adhesive film 140 of the embodiment of FIG. 2 is preferably attached to the surfaces of the protruding portions 230. Reference symbol 320 designates a grip, and reference symbol 330 designates a wastebasket hook eye.

The present embodiment has an advantage in that a single wastebasket body and a single wastebasket lid are included.

Meanwhile, the scope of the present invention is not limited to the specific composition and fabrication process of plastic bags. Furthermore, the scope of the present invention is not limited to the descriptions and expressions of the embodiments explicitly described above. Finally, it is also added that the scope of the present invention may not be limited by an alteration or substitution that is obvious to in the art to which the present invention pertains.

1. A wastebasket in which one plastic bag cartridge is contained, wherein:
a plastic bag cartridge including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction, the plastic bag cartridge being packaged such that the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line, is replaceably mounted in a bottom portion of the wastebasket; and
an adhesive film configured to enhance force holding the entrance of the unit plastic bag is disposed along an upright surface (135) surrounding the top entrance of the wastebasket, and a lid (120) configured to close the top entrance of the wastebasket while coming into contact with a protruding surface (130) formed perpendicular to the upright surface (135) is provided.

2. The wastebasket of claim 1, wherein the plastic bag cartridge is configured such that the unit plastic bags are wound in a roll pack form or the unit plastic bags are folded and stacked with a location of the sealing line changed at intervals of 180 degrees.

3. A wastebasket in which one plastic bag cartridge is contained inside the wastebasket and a vinyl sheet cartridge is attached to any surface of an outside of the wastebasket body, wherein:
the plastic bag cartridge is configured such that successive plastic bags in which unit plastic bags are successively connected to each other are contained therein, is replaceably mounted in a bottom portion of the wastebasket, and is packaged such that a sealing line is provided in an end portion of each of the unit plastic bags opposite to an entrance end thereof, the unit plastic bags have same specifications and are successively connected to each other, a cutting line is provided between a sealing line of the each unit plastic bag and a subsequent unit plastic bag, and an entrance end of the subsequent unit plastic bag is opened when the each unit plastic bag is separated by cutting the cutting line; and
the vinyl sheet cartridge is configured such that lid protecting vinyl sheets are folded and stacked therein, and an adhesive film configured to allow each of the lid protecting vinyl sheets to be adhered thereto is disposed on an inner surface of a wastebasket lid so that the lid protecting vinyl sheet is taken from the vinyl sheet cartridge and adhered to the inner surface of the wastebasket lid.

4. The wastebasket of claim 3, wherein an adhesive film configured to enhance force holding the entrance of the unit plastic bag is disposed along an upright surface surrounding the top entrance of the wastebasket, and the wastebasket lid closes the top entrance of the wastebasket while coming into contact with a protruding surface formed perpendicular to the upright surface.

5. The wastebasket of claim 3, wherein each of the unit plastic bags is configured such that symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction

6. The wastebasket of claim 3, wherein the plastic bag cartridge is configured such that the unit plastic bags are wound in a roll pack form or the unit plastic bags are folded and stacked with the location of the sealing line changed at intervals of 180 degrees.

7. Successive plastic bags comprising unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction, wherein the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line.

8. Successive plastic bags comprising unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction, wherein the unit plastic bags have same specifications, are successively connected to each other and are folded and stacked with a location of the sealing line changed at intervals of 180 degrees, a cutting line is provided between a sealing line of each unit plastic bag and a subsequent unit plastic bag, and an entrance end of the subsequent unit plastic bag is opened when the each unit plastic bag is separated by cutting the cutting line.

9. A plastic bag cartridge comprising unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction, wherein the unit plastic bags have same specifications, are successively connected to each other, and are wound in a roll pack form or folded and stacked with a location of the sealing changed at intervals of 180 degrees,
wherein the plastic bag cartridge is packaged such that a cutting line is provided between a sealing line of each unit plastic bag and a subsequent unit plastic bag and an entrance end of the subsequent unit plastic bag is opened when the each unit plastic bag is separated by cutting the cutting line, is replaceably mounted in a wastebasket, and is configured such that the subsequent plastic bag is opened and disposed in the wastebasket when the each unit plastic bag is separated from the wastebasket.

10. A wastebasket in which one or more plastic bag cartridges are contained, wherein:
a plastic bag cartridge including unit plastic bags in each of which symmetrical, sideways M-shaped folded portions (M1 and M2) are provided on both sides thereof in a longitudinal direction and a sealing line is provided in an end portion thereof opposite to an entrance end thereof in a state in which one of both the sides has been turned to a remaining side around 180 degrees along a center portion thereof in the longitudinal direction, the plastic bag cartridge being packaged such that the unit plastic bags have same specifications, are successively connected to each other and are wound in a roll pack form, a cutting line is provided between a sealing line of each unit plastic bag and a subsequent unit plastic bag, and an entrance end of the subsequent unit plastic bag is opened when the each unit plastic bag is separated by cutting the cutting line, is replaceably mounted in a bottom portion of the wastebasket; and
protruding portion lines each including a plurality of protruding portions configured to hold an entrance of each of the unit plastic bags supplied from the plastic bag cartridge are disposed along both opposite sides of a top entrance of the wastebasket.

11. The wastebasket of claim 10, wherein the plastic bag cartridge is configured such that the unit plastic bags are wound in a roll pack form or the unit plastic bags are folded and stacked with the location of the sealing line changed at intervals of 180 degrees.

12. The wastebasket of claim 10, wherein an adhesive film configured to enhance force holding the entrance of the unit plastic bag is attached onto surfaces of protruding portion lines on both opposite sides of the top entrance of the wastebasket.
